(19) United States
(12) Patent Application Publication
(10) Pub. No.: US 2018/0231154 A1
(43) Pub. Date: Aug. 16, 2018

(54) INTEGRAL TUBE BODY AND THREADED CONNECTOR STRUCTURE OF RV CONNECTING TUBE

(71) Applicant: SHEN-EN CHIANG, Taichung City (TW)

(72) Inventor: SHEN-EN CHIANG, Taichung City (TW)

(21) Appl. No.: 15/439,104

(22) Filed: Feb. 22, 2017

(30) Foreign Application Priority Data
Feb. 16, 2017 (TW) 106202206

(51) Int. Cl. F16L 15/00

(52) U.S. Cl. CPC F16L 15/00

(57) ABSTRACT

An integral tube body and threaded connector structure of an RV connecting tube is provided. The RV connecting tube includes at least two hard connectors and a soft tube body. Each hard connector includes a threaded portion. The soft tube body has two ends. The hard connectors are integrally jointed to the two ends of the soft tube body by injection molding. The hard connectors and the soft tube body are integrally jointed to each other by injection molding, so there is no leakage problem caused by environmental factors after long-time use. The threaded portion of the hard connector can be directly screwed to a tube to be connected, achieving the stability of the structure and the convenience of use.

### FIELD OF THE INVENTION

The present invention relates to a connecting tube structure for an RV, and more particularly to an integral tube body and threaded connector structure of an RV connecting tube.

### BACKGROUND OF THE INVENTION

FIG. 5 and FIG. 6 illustrate a conventional RV connecting tube structure. A glued connecting tube 30 comprises a tube connector 31, a tube body 32, and a bonding adhesive 33. The tube connector 31 has a front fitting portion 310, a rear fitting portion 311, and a stopping portion 312 between the front fitting portion 310 and the rear fitting portion 311. The rear fitting portion 311 of the tube connector 31 is connected with the end of the tube body 32 and sealed with the bonding adhesive 33. The front fitting portion 310 of the tube connector 31 is connected with a tube 20. The connecting tube 30 is retained by a plurality of retaining members 40. The joint of the tube connector 31 and the tube body 32 is provided with the bonding adhesive 33. The bonding adhesive 33 may be damaged because of the change of environmental factors or long-time use to cause a leakage between the tube connector 31 and the tube body 32. It is necessary to cooperate with the retaining members 40, causing great inconvenience for use and assembly. The tube body 32 cannot be bent with ease. Accordingly, the inventor of the present invention has devoted himself based on his many years of practical experiences to solve these problems.

### SUMMARY OF THE INVENTION

In view of the problems of the prior art, the primary object of the present invention is to provide an integral tube body and threaded connector structure of an RV connecting tube.

In order to achieve the aforesaid object, the RV connecting tube of the present invention comprises at least two hard connectors and a soft tube body. Each hard connector includes a threaded portion, a coupling portion, and a stopping plate between the threaded portion and the coupling portion. The stopping plate is in a circular shape. An end of the threaded portion is provided with a reduced protruding neck. An inner side of the coupling portion is provided with an annular inner engaging wall. The soft tube body has two ends. An outer side of each end of the soft tube body is provided with an outer engaging wall. The coupling portions of the hard connectors face the ends of the soft tube body. The inner engaging wall of the coupling portion is tightly fixed to the outer engaging wall of the corresponding end of the soft tube body. The inner engaging wall of the coupling portion and the outer engaging wall of the corresponding end are integrally joined together by injection molding. The hard connectors and the soft tube body are tightly joined to each other by injection molding, so there is no leakage problem caused by environmental factors after long-time use. The threaded portion provided at one end of the hard connector can be directly screwed to an internal locking portion of a tube to be connected, enabling the reduced protruding neck at the front end of the threaded portion to be inserted into the tube. There is no need for an additional fixing assembly to simplify the installation of the connecting tube to enhance the ease of use. The stopping plate disposed between the threaded portion and the coupling portion of the hard connector may be in a polygonal shape, which can be changed according to the use of different needs. The soft tube body can be bent easily according to the user's needs, achieving the stability of the structure and the convenience of use.

### BRIEF DESCRIPTION OF THE DRAWINGS

FIG. 1 is a perspective schematic view of an integral tube body and threaded connector structure of an RV connecting tube of the present invention;

FIG. 2 is a partial sectional view of the integral tube body and threaded connector structure of the RV connecting tube of the present invention;

FIG. 3 is a schematic view of the integral tube body and threaded connector structure of the RV connecting tube of the present invention, showing a threaded portion of a hard connector screwed to an internal locking portion of a tube to be connected;

FIG. 4 is a schematic view of the integral tube body and threaded connector structure of the RV connecting tube of the present invention, showing a polygonal stopping plate provided on the hard connector according to an embodiment;

FIG. 5 is a perspective schematic view of a conventional RV connecting tube; and

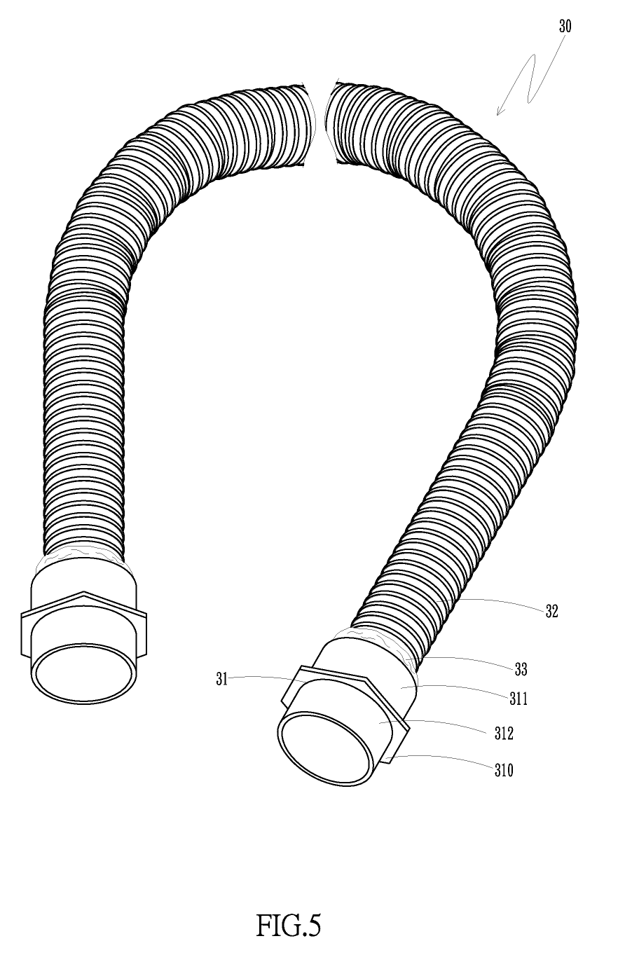

FIG. 6 is a schematic view of the conventional RV connecting tube when in use.

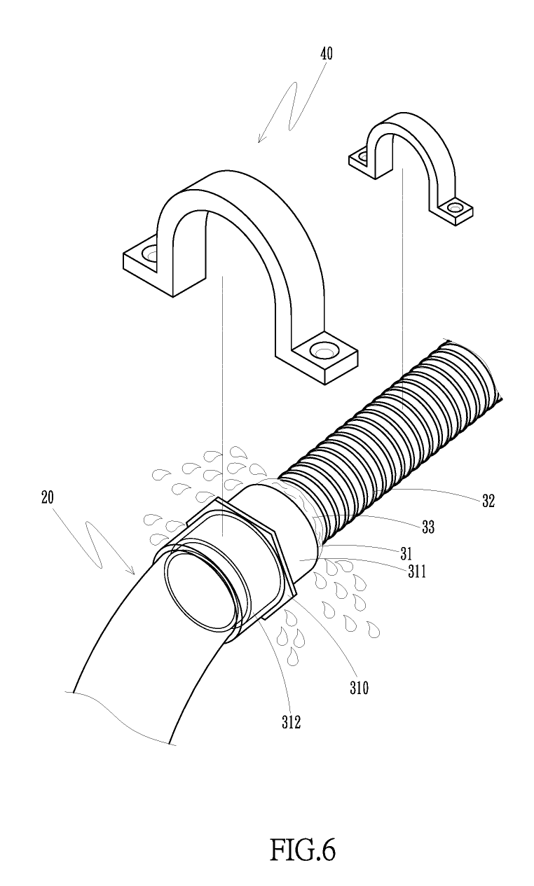

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

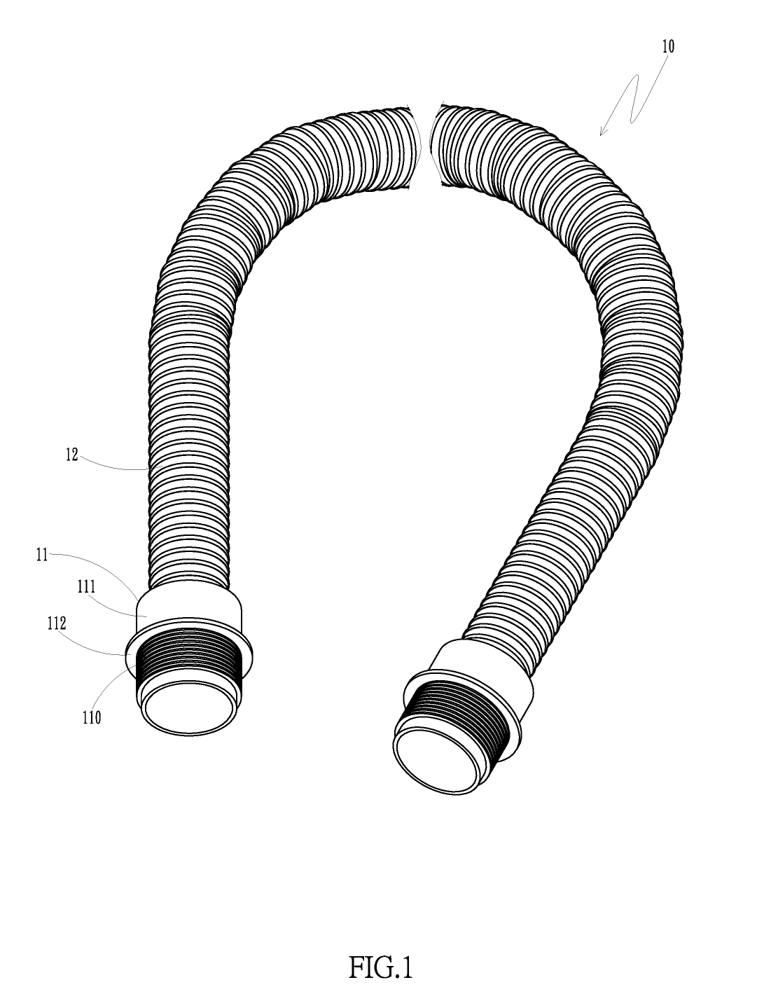

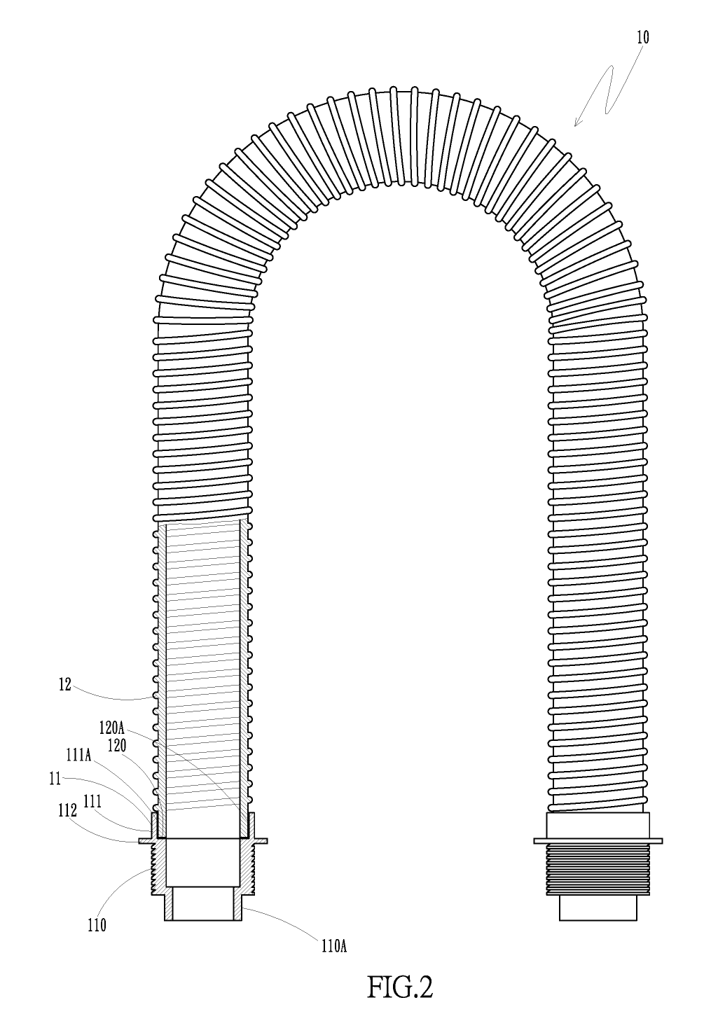

FIG. 1 is a perspective schematic view of an integral tube body and threaded connector structure of an RV connecting tube of the present invention. FIG. 2 is a partial sectional view of the integral tube body and threaded connector structure of the RV connecting tube of the present invention. An RV connecting tube 10 comprises at least two hard connectors 11 and a soft tube body 12. Each hard connector 11 includes a threaded portion 110, a coupling portion 111, and a stopping plate 112 between the threaded portion 110 and the coupling portion 111. The stopping plate 112 is in a circular shape. An end of the threaded portion 110 is provided with a reduced protruding neck 110A. An inner side of the coupling portion 111 is provided with an annular inner engaging wall 111A. The soft tube body 12 has two ends 120. An outer side of each end 120 is provided with an outer engaging wall 120A. The coupling portions 111 of the hard connectors 11 face the ends 120 of the soft tube body 12. The inner engaging wall 111A of the coupling portion 111 is tightly fixed to the outer engaging wall 120A of the corresponding end 120. The inner engaging wall 111A of the coupling portion 111 and the outer engaging wall 120A of the corresponding end 120 are integrally joined to each other by injection molding.

Thereby, the integral tube body and threaded connector structure of the RV connecting tube of the present invention is completed.

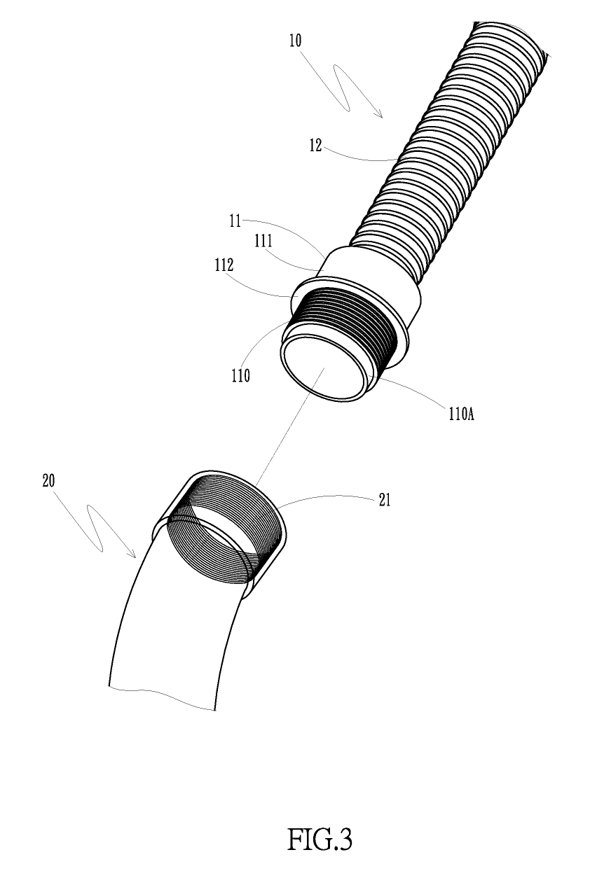

FIG. 1 is a perspective schematic view of the integral tube body and threaded connector structure of the RV connecting tube of the present invention. FIG. 2 is a partial sectional view of the integral tube body and threaded connector structure of the RV connecting tube of the present invention. FIG. 3 is a schematic view of the integral tube body and threaded connector structure of the RV connecting tube of the present invention, showing the threaded portion of the hard connector screwed to an internal locking portion of a tube to be connected. The coupling portions 111 of the hard connectors 11 face the ends 120 of the soft tube body 12. The inner engaging wall 111A of the coupling portion 111 is tightly fixed to the outer engaging wall 120A of the corresponding end 120. The inner engaging wall 111A of the coupling portion 111 and the outer engaging wall 120A of the corresponding end 120 are integrally joined to each other by injection molding. The hard connectors 11 and the soft tube body 12 are tightly joined to each other by injection molding, so there is no leakage problem caused by environmental factors after long-time use. The threaded portion 110 provided at one end of the hard connector 11 can be directly screwed to an internal locking portion 21 of a tube 20 to be connected, enabling the reduced protruding neck 110A at the front end of the threaded portion 110 to be inserted into the tube 20. There is no need for an additional fixing assembly to simplify the installation of the connecting tube to enhance the ease of use. The soft tube body can be bent easily according to the user's needs, achieving the stability of the structure and the convenience of use.

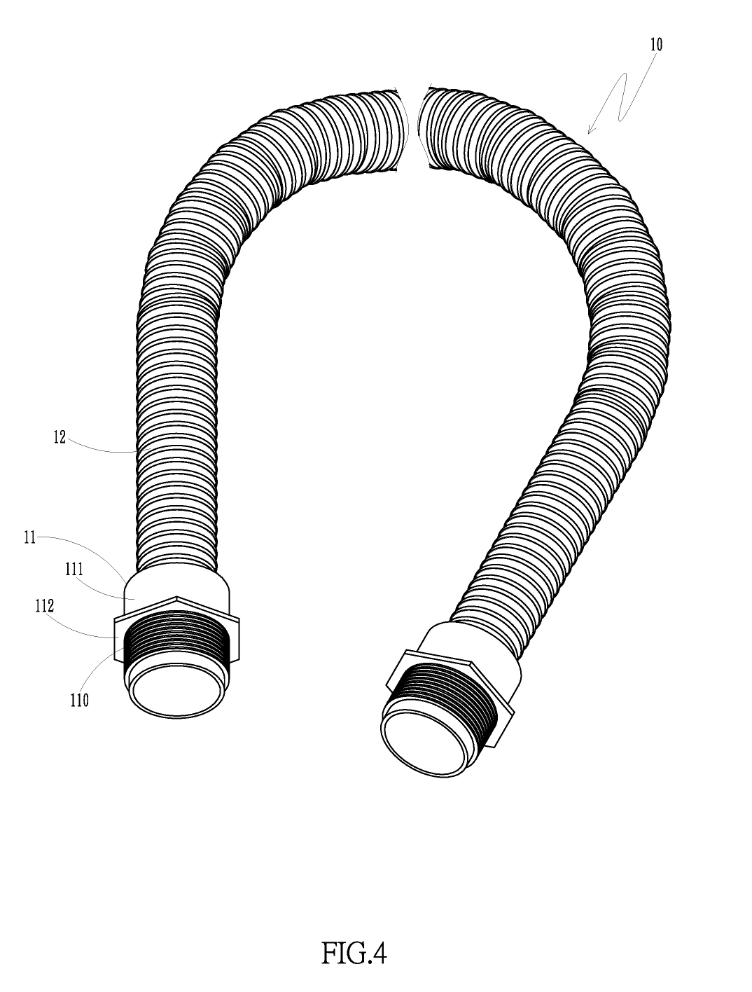

FIG. 4 is a schematic view of the integral tube body and threaded connector structure of the RV connecting tube of the present invention, showing a polygonal stopping plate provided on the hard connector according to an embodiment. The entire structure of this embodiment is substantially similar to that of FIG. 1 to FIG. 3. The stopping plate 112 disposed between the threaded portion 110 and the coupling portion 111 of the hard connector 11 is in a polygonal shape, which can be changed according to the use of different needs to add the variety of the present invention.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An integral tube body and threaded connector structure of an RV (recreational vehicle) connecting tube, characterized by:
the RV connecting tube comprising at least two hard connectors and a soft tube body, the hard connectors each including a threaded portion and a coupling portion, the soft tube body having two ends, the coupling portions of the hard connectors and the ends of the soft tube body being integrally joined to each other.

2. The integral tube body and threaded connector structure of an RV connecting tube as claimed in claim 1, wherein the hard connectors each include a stopping plate disposed between the threaded portion and the coupling portion.

3. The integral tube body and threaded connector structure of an RV connecting tube as claimed in claim 2, wherein the stopping plate has a circular shape.

4. The integral tube body and threaded connector structure of an RV connecting tube as claimed in claim 2, wherein the stopping plate has a polygonal shape.

5. The integral tube body and threaded connector structure of an RV connecting tube as claimed in claim 1, wherein the hard connectors and the soft tube body are integrally joined to each other by injection molding.

6. The integral tube body and threaded connector structure of an RV connecting tube as claimed in claim 1, wherein an inner side of the coupling portion of each hard connector is provided with an annular inner engaging wall, an outer side of each end of the soft tube body is provided with an outer engaging wall, the coupling portions of the hard connectors face the ends of the soft tube body, and the inner engaging wall of the coupling portion is tightly fixed to the outer engaging wall of a corresponding one of the ends.

7. The integral tube body and threaded connector structure of an RV connecting tube as claimed in claim 6, wherein the hard connectors and the soft tube body are integrally joined to each other by injection molding.

8. The integral tube body and threaded connector structure of an RV connecting tube as claimed in claim 1, wherein an end of the threaded portion of each hard connector is provided with a reduced protruding neck.
